(19) United States
(12) Patent Application Publication
(10) Pub. No.: US 2025/0150797 A1
(43) Pub. Date: May 8, 2025

(54) HANDLING BLOCKAGE OF COMMUNICATION FOR USER EQUIPMENT IN INDUSTRIAL ENVIRONMENT

(71) Applicant: Telefonaktiebolaget LM Ericsson (publ), Stockholm (SE)

(72) Inventors: Hideshi MURAI, Kanagawa (JP); Junaid ANSARI, Aachen (DE); Jan DIEKMANN, Düsseldorf (DE); Leefke GROSJEAN, Täby (SE)

(21) Appl. No.: 18/838,041

(22) PCT Filed: Feb. 14, 2022
(86) PCT No.: PCT/SE2022/050161

§ 371 Date: Aug. 13, 2024

(51) Int. Cl. H04W 4/70; H04W 40/22

(52) U.S. Cl. CPC H04W 4/70; H04W 40/22

(57) ABSTRACT

Embodiments of the present disclosure provide a method performed by a first user equipment (UE), for reception of communication from a network node in an industrial environment. The industrial environment includes a plurality of industrial devices, a first industrial device being connected to the first UE, and one or more second industrial devices being connected to one or more second UEs. The method includes determining whether the communication to the first UE is being blocked by one of: the first industrial device, or the one or more second industrial devices, in the industrial environment. While the communication is determined to be blocked, the method includes receiving the communication from the network node through one or more of: an antenna positioned on the first industrial device, and a second UE connected to the second industrial device. Corresponding first UE, an industrial controller and computer program products are also disclosed.

### TECHNICAL FIELD

The present disclosure relates generally to the field of industrial environment. More particularly, it relates to methods, user equipment, UE, industrial controller, and computer program products for reception of communication in an industrial environment.

### BACKGROUND

Industrial automation is becoming increasingly popular due to rapid development in sensors, control system, and other manufacturing techniques. In industrial automation, various kinds of industrial devices (such as 6DOF robotic arms, collaborating robotic arms, Automated Guided Vehicles, AGVs, with omni-wheels, excavators, or other robotic devices) are used to automate various process in industries. For example, an industrial environment includes a plurality of industrial devices that receive control messages from an industrial controller and perform assigned one or more operations.

In the industrial environment, the plurality of industrial devices can be connected to a plurality of user equipments, UEs, connected to a network node. The plurality of industrial devices can receive the control messages from the industrial controller through the plurality of UEs and perform the one or more operations.

While operating in the industrial environment, the one or more industrial devices may block communication from the network node to the one or more UEs. The communication can be collectively referred to, communication signals involving control signaling, control messages, or the like. Further, when the network node supports at least one of: millimetre wave, mmWave, communication, or terahertz, THz communication, a frequency of causing blockage of the communication from the network node to the one or more UEs by the one or more industrial devices can be increased, as deflection cannot be expected.

FIGS. 1A and 1B depict an example industrial environment 100. In an example, as depicted in FIG. 1A, the industrial environment 100 comprises an industrial device 102 connected to a UE 104 and the UE 104 may be in communication with a network node 106. While operating in the industrial environment 100, the industrial device 102 may block communication from the network node 106 to the UE 104.

In another example, as depicted in FIG. 1B, the industrial environment comprises multiple industrial devices, for example, an industrial device 102a and an industrial device 102b. The industrial device 102a and the industrial device 102b are connected to a UE 104a, and a UE 104b, respectively. While operating in the industrial environment, the industrial device 102a may block communication from the network node 106 to the UE 104b connected to the industrial device 102b.

In both the above described examples, when there is a blockage of communication for the UE 104/104b from the network node 106, the UE 104 supporting at least one multi-directive antenna can switch from a serving antenna to at least one another antenna for receiving communication from the network node, as depicted in FIG. 1C. The UE 104/104b can switch to the at least one another antenna based on a direction of arrival of communication from the network node 106. However, time required for such antenna switching can be too long for services, for example, ultra-reliable and low latency communication, URLLC, services, that include stringent low latency requirements.

### SUMMARY

Consequently, there is a need for an improved method and arrangement for reception of communication in an industrial environment that alleviates at least some of the above cited problems.

It is therefore an object of the present disclosure to provide a method, a user equipment, UE, and an industrial controller to mitigate, alleviate, or eliminate all or at least some of the above-discussed drawbacks of presently known solutions.

This and other objects are achieved by means of a method, a user equipment, UE, an industrial controller, and a computer program product as defined in the appended claims. The term exemplary is in the present context to be understood as serving as an instance, example or illustration.

According to a first aspect of the present disclosure, a method is performed by a first user equipment UE, for reception of communication from a network node in an industrial environment. The industrial environment comprises a plurality of industrial devices, a first industrial device being connected to the first UE, and one or more second industrial devices being connected to one or more second UEs. The method comprises determining whether the communication to the first UE is being blocked by one of: the first industrial device, or the one or more second industrial devices in the industrial environment. While the communication is determined to be blocked, the method comprises receiving the communication from the network node through one or more of: an antenna positioned on the first industrial device, and a second UE connected to the second industrial device.

In some embodiments, the step of determining whether the communication to the first UE is being blocked by one of: the first industrial device, or the one or more second industrial devices comprises one or more of: identifying whether the first industrial device is blocking the communication from the network node to the first UE using an operating state of the first industrial device, and identifying whether the one or more second industrial devices are blocking the communication from the network node to the first UE using an operating state of the one or more second industrial devices.

In some embodiments, the operating state of the first industrial device and/or the operating state of the one or more second industrial devices is determined using information received from one or more of: one or more sensors positioned on the first industrial device, and/or one or more sensors positioned on the one or more second industrial devices, and an industrial controller configured for controlling each industrial device in the industrial environment.

In some embodiments, the step of receiving the communication from the network node through one or more of: the antenna positioned on the first industrial device, and the second UE connected to the second industrial device comprises determining whether the first industrial device is blocking the communication from the network node. While determined that the first industrial device is blocking the communication, the method further comprises receiving the communication from the network node through the antenna positioned on the first industrial device.

The method further comprises identifying that the communication is blocked for the first UE due to a movement of the first industrial device. The method further comprises determining to switch to at least one antenna of the first UE for the reception of communication from the network node, wherein switching to the at least one antenna is based on the determined operating state of the first industrial device.

The method further comprises determining whether the one or more second industrial devices are blocking the communication from the network node. While determined that the one or more second industrial devices are blocking the communication from the network node, the method further comprises receiving the communication from the network node through the second UE connected to the second industrial device.

In some embodiments, the step of receiving the communication from the network node through the second UE connected to the second industrial device comprises receiving, from an industrial controller, an indication to receive the communication from the network node through the second UE. The method further comprises receiving the communication from the network node through the second UE.

According to a second aspect of the present disclosure, a method for enabling a first user equipment, UE, for reception of communication from a network node, in an industrial environment. The industrial environment comprising a plurality of industrial devices, each industrial device being connected to a UE. The method is performed by an industrial controller connected to the network node. The method comprises determining that the communication to the first UE is being blocked by one of: a first industrial device, or one or more second industrial devices, in the industrial environment. The method comprises causing the first UE to receive the communication from the network node through one or more of: an antenna positioned on the first industrial device, and a second UE connected to the second industrial device.

In some embodiments, the step of determining that the communication to the first UE is being blocked by one of: the first industrial device, or the one or more second industrial devices in the industrial environment comprises receiving sensor data acquired using one or more sensors positioned on each of the plurality of industrial devices. The method further comprises receiving information related to a movement of the plurality of industrial devices. The method further comprises determining that the communication to the first UE is being blocked by one of: the first industrial device, or the one or more second industrial devices using the sensor data and the information related to the movement of the plurality of industrial devices.

In some embodiments, the step of causing the first UE to receive the communication from the network node comprises determining a second UE and an antenna of the second UE to be used to relay the communication from the network node to the first UE through the second UE. The method further comprises transmitting to the first UE, an indication related to the second UE to cause the first UE to receive the communication from the network node.

In some embodiments, the step of determining the second UE and the antenna of the second UE to be used to relay the communication from the network node to the first UE through the second UE comprises determining a traffic condition of one or more second UEs connected to the one or more second industrial devices. The method further comprises determining radio channel conditions between the network node and the one or more UEs for communication to the one or more UEs. The method further comprises determining the second UE and the antenna of the second UE to be used to relay the communication from the network node using the traffic condition of the one or more second UEs and the radio channel conditions.

According to a third aspect of the present disclosure, a first user equipment, UE, configured to operate in an industrial environment for reception of communication from a network node. The industrial environment comprises a plurality of industrial devices, a first industrial device being connected to the first UE, and one or more second industrial devices being connected to one or more second UEs. The first UE comprises a controlling circuitry configured to cause determination of whether the communication to the first UE is being blocked by one of: the first industrial device, or the one or more second industrial devices in the industrial environment. While the communication is determined to be blocked, the controlling circuitry is configured to cause reception of the communication from the network node through one or more of: an antenna positioned on the first industrial device, and a second UE connected to the second industrial device.

According to a fourth aspect of the present disclosure, an industrial controller for enabling a first user equipment, UE, for reception of communication from a network node, in an industrial environment. The industrial environment comprising a plurality of industrial devices, each industrial device being connected to a UE. The industrial controller comprises a controlling circuitry configured to cause determination of that the communication to the first UE is being blocked by one of: a first industrial device, or one or more second industrial devices, in the industrial environment. The controlling circuitry is configured to cause the first UE to receive the communication from the network node through one or more of: an antenna positioned on the first industrial device, and a second UE connected to the second industrial device.

A fifth aspect is an industrial controller comprising an apparatus of the fourth aspect.

According to a sixth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for relaying communication from a network node to a user equipment, UE, in an industrial environment, when there is a blockage of communication by one or more industrial devices.

An advantage of some embodiments is that an antenna may be positioned on an industrial device. Therefore, the UE connected to the industrial device may receive the communication from the network node through the antenna positioned on the industrial device, when the industrial device blocks the communication from the network node to the UE.

An advantage of some embodiments is that the UE may switch to at least one antenna for receiving the communication from the network node based on an operating state of the industrial device to which the UE is connected. As a result, time required for switching to the at least one antenna may be reduced.

An advantage of some embodiments is that transmitting an indication by the UE to the network node indicating switching to at least one antenna by the UE for receiving the communication. As a result, preparation for beam switching may be possible at the network node with reduced signaling for transmitting the communication to the UE.

An advantage of some embodiments is that enabling the UE to receive the communication from the network node through another UE, when the industrial device other than the industrial device to which the UE is connected blocks the communication to the UE from the network node. As a result, the communication may be relayed to the UE even when the one or more industrial devices block the communication for the UE in the industrial environment.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B disclose an example industrial environment;

FIG. 1C discloses an example illustration of antenna switching performed by a user equipment, UE;

FIG. 2 discloses an example industrial environment, according to some embodiments;

FIG. 3 is a flowchart illustrating example method steps according to some embodiments;

FIGS. 4A-4D disclose example illustrations for receiving communication by a UE from a network node, according to some embodiments;

FIG. 5 is a flowchart illustrating example method steps according to some embodiments;

FIG. 6 discloses an example illustration for receiving communication by the UE from the network node, according to some embodiments;

FIG. 7 is a flowchart illustrating example method steps according to some embodiments;

FIG. 8 is a flowchart illustrating example method steps according to some embodiments;

FIG. 9 is a schematic block diagram illustrating an example apparatus according to some embodiments;

FIG. 10 is a schematic block diagram illustrating an example apparatus according to some embodiments;

FIG. 11 is a schematic block diagram illustrating an example apparatus according to some embodiments; and

FIG. 12 discloses an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

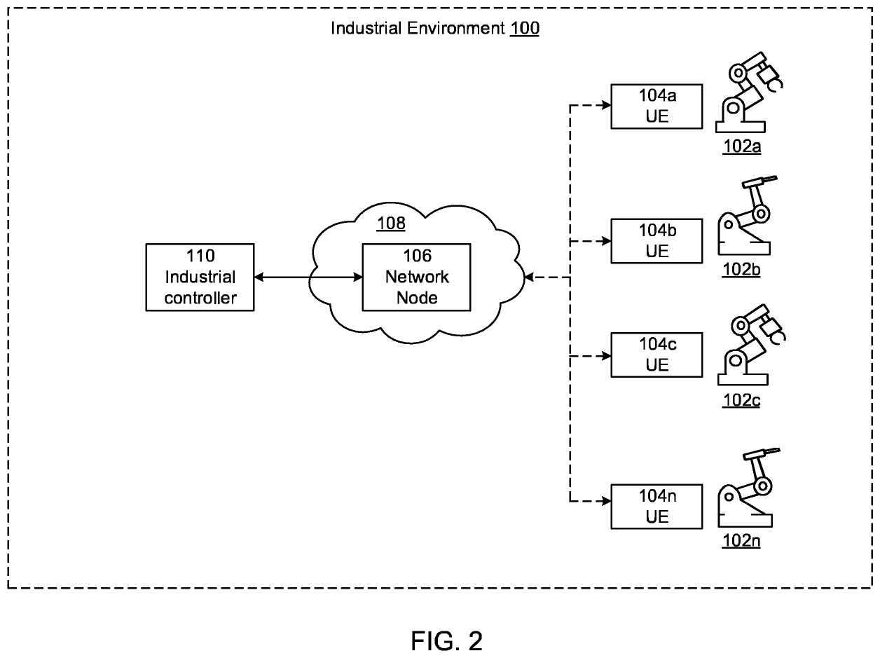

FIG. 2 discloses an example industrial environment 100. Some of the examples of the industrial environment 100 may include a factory, a manufacturing unit, guided robotic environment, a construction site, or the like. The industrial environment 100 comprises a plurality of industrial devices 102a-102n, and a plurality of user equipments, UEs, 104a-104n. Each of the plurality of industrial devices 102a-102n may be connected to a UE (104a-104n). Further there exists a network node 106 in a wireless communication network 108. The network node 106 may be connected to the plurality of UEs 104a-104n. The network node 106 may also be connected to an industrial controller 110. It should be noted that the industrial environment 100 is not limited to above-mentioned components, other components can also be present in the industrial environment 100 other than the components shown in the FIG. 2.

In some examples, the plurality of industrial devices 102a-102n may be a device that is stationary or mobile, and also may be referred to as a peripheral, a machinery, or the like. Examples of the plurality of industrial devices 102a-102n may include, but are not limited to, an industrial robot, a robotic arm, an automation cell, a conveyor, an excavator, a lifter, a turn-over machine, an Internet of Things device, IoT device, a 6DOF robotic arm, collaborating robotic arms, Automated Guided Vehicles, AGVs, with omni-wheels, or any other similar device.

The plurality of industrial devices 102a-102n may be connected to the plurality of UEs 104a-104n. In some examples, the plurality of industrial devices 102a-102n may be connected to the plurality of plurality of UEs 104a-104n using at least one of: a wired network, a cellular network, a wireless local area network, LAN, Wi-Fi, Bluetooth, Bluetooth low energy, Zigbee, Wi-Fi direct, WFD, Ultra-wideband, UWB, infrared data association, IrDA, near field communication, NFC, and so on.

The plurality of industrial devices 102a-102n may be configured to perform one or more operations in accordance with one or more control messages generated by the industrial controller 110. In some examples, the plurality of industrial devices 102a-102n may comprise one or more actuators, for example, servos, arms, or the like, for performing the one or more operations. The plurality of industrial devices 102a-102n may receive the one or more control messages from the network node 106 through the plurality of UEs 104a-104n. The control messages may comprise a set of commands intended for the plurality of industrial devices 102a-102n from the industrial controller 110. The set of commands instruct the plurality of industrial devices 102a-102n how to perform the one or more operations. The one or more operations performed by each of the plurality of industrial devices 102a-102n may depend on an industrial application being implemented on each of the plurality of industrial devices 102a-102n. The industrial application may include, an industrial process automation based application, a building automation based application, an application intended for monitoring electrical distribution networks, or the like.

The plurality of UEs 104a-104n may be a wireless device that is stationary or mobile and may also be referred to as a remote station, a mobile station, mobile equipment, a terminal, a remote terminal, an access terminal, or the like. Examples of the wireless device may include, but are not limited to, a cellular phone, a personal digital assistant, PDA, a wireless modem, a wireless communication device, a handheld device, a subscriber unit, a laptop computer, and so on.

The plurality of UEs 104a-104n may be connected to the plurality of industrial devices 102a-102n, and the network node 106 residing in the wireless communication network 108.

The plurality of UEs 104a-104n may be configured to receive communication from the network node 106. The communication may also be referred to as a signal, control signaling, a radio wave, a communication signal, or the like. In some examples, the communication may be collectively referred to one or more of: downlink control channel information, broadcast signals and messages, broadcast data channels, multicast and unicast data, control signals, the control messages, and so on. The plurality of UEs 104a-104n may also be configured to forward the control messages to the intended plurality of industrial devices 102a-102n.

In some examples, the network node 106 may be a radio node residing in the wireless communication network 108.

In some examples, the wireless communication network 108 may include, but are not limited to, a cellular network, a wireless LAN, Wi-Fi, Bluetooth, Bluetooth low energy, Zigbee, Wi-Fi direct, WFD, Ultra-wideband, UWB, infrared data association, IrDA, near field communication, NFC, and so on. In some examples, the wireless communication network 108 supports one or more of: a millimetre wave, mmWave, communication, and terahertz, THz, communication.

In some examples, the radio node may include, but are not limited to, an evolved node, eNB, a gNodeB, gNB, a local access network, LAN node, a wireless LAN, WLAN, node, a Wi-Fi node, or the like. In some examples, the radio node may include the internet supporting one or more communication protocols for transmission of the communication.

The network node 106 may be configured to transmit the communication to the plurality of UEs 104a-104n. In some examples, the network node 106 may employ directional transmissions and receptions with beamforming methods. In accordance with the beamforming methods, the network node 106 forms one or more beams for serving the plurality of UEs 104a-104n. The network node 106 transmits the communication to the plurality of UEs 104a-104n in the formed one or more beams.

In some examples, the industrial controller 110 may include, but are not limited to, a factory automation equipment, FA equipment, a computing device, a multi-processor system, a microprocessor-based or programmable consumer electronic device, a network computing device, a minicomputer, a mainframe computer, or a combination thereof. The computing device may include a cellular phone, a personal digital assistant, PDA, a handheld device, a laptop computer, or a combination thereof.

In some examples, the industrial controller 110 may be implemented in one or more of: a cloud server, an edge server, or the like. The industrial controller 110 may be connected to the network node 106. In some examples, the industrial controller 110 may be connected to the network node 106 using at least one of: a wired network, a cellular network, a wireless local area network, LAN, Wi-Fi, Bluetooth, Bluetooth low energy, Zigbee, WFD, UWB, IrDA, near field communication, NFC, and so on.

The industrial controller 110 may be configured to monitor and control the one or more operations of the plurality of industrial devices 102a-102n over the wireless communication network 108. The industrial controller 110 generates the one or more control messages for controlling the one or more operations of the plurality of industrial devices 102a-102n. In some examples, the industrial controller 110 may include suitable programmable logic controller, PLC, circuitry, interfaces, and/or code that may be configured to generate the one or more control messages intended for the plurality of industrial devices 102a-102n.

The industrial controller 110 transmits the control messages intended to the plurality of industrial devices 102a-102n to the network node 106. The network node 106 transmits the control messages to the plurality of industrial devices 102a-102n through the plurality of UEs 104a-104n.

While operating in the industrial environment 100, the one or more industrial devices 102a-102n may block the communication from the network node 106 to the one or more UEs 104a-104n. When there is a blockage of communication, the one or more UEs 104a-104n perform an antenna switching for receiving the communication from the network node 106. However, time required for performing the antenna switching may be too long for services with low latency requirements.

Therefore, according to some embodiments of the present disclosure, a first UE, for example, UE 104a, of the plurality of UEs 104a-104n implements a method for receiving the communication from the network node 106. Although the embodiments described herein may be equally applicable for the plurality of UEs 104a-104n, the embodiments herein are described by considering the first UE 104a among the plurality of UEs 104a-104n, which implements the method for receiving the communication from the network node 106. Furthermore, the industrial controller 110 implements a method for enabling the first UE 104a to receive the communication from the network node 106.

In the embodiments described herein, the industrial device, for example, the industrial device 102a, connected to the first UE 104a may be referred to as a first industrial device 102a. One or more other industrial devices 102b-102n may be referred to as second industrial devices 102b-102n. The UEs, for examples, the UEs 104b-104n connected to the second industrial devices 102b-102n may be referred to as second UEs 104b-104n.

According to some embodiments of the present disclosure, the first UE 104a determines whether the communication to the first UE 104a is being blocked by one of: the first industrial device 102a, or the one or more second industrial devices 102b-102n in the industrial environment 100. While the communication is determined to be blocked, the first UE 104a receives the communication from the network node 106 through one or more of: an antenna positioned on the first industrial device 102a, and the second UE, for example, the second UE 104b, connected to the second industrial device 102b.

According to some embodiments of the present disclosure, the industrial controller 110 determines that the communication to the first UE 104a is being blocked by one of: a first industrial device 102a, or one or more second industrial devices (102b-102n), in the industrial environment 100. The industrial controller 110 causes the first UE 104a to receive the communication from the network node 106 through one or more of: the antenna positioned on the first industrial device 102a, and the second UE 104b connected to the second industrial device 102b.

Various embodiments for receiving the communication by the first UE 104a from the network node 106 are explained in conjunction with figures in the later parts of the description.

Above explained method for receiving the communication by the first UE 104a from the network node 106 enables the first UE 104a to receive the communication through one or more of, the antenna positioned on the first industrial device, or the second UE, even when there is blockage of the communication from the network node 106 by the first industrial device 102a or the one or more second industrial devices 102b-102n. Therefore, the first UE 104a may not be required to perform the antenna switching to receive the communication. As a result, the first UE 104a may receive the communication without any latency.

In addition, above explained method for causing, by the industrial controller 110, the first UE 104a to receive the communication from the network node 106 involves transmitting an indication to the first UE 104a and the network node 106 indicating that the communication is determined to be blocked by one of: the first industrial device 102a, or the one or more second industrial devices 102b-102n. Thus, in accordance with the received indication, the first UE 104a/network node 106 may prepare for receiving/transmitting the communication with reduced signaling.

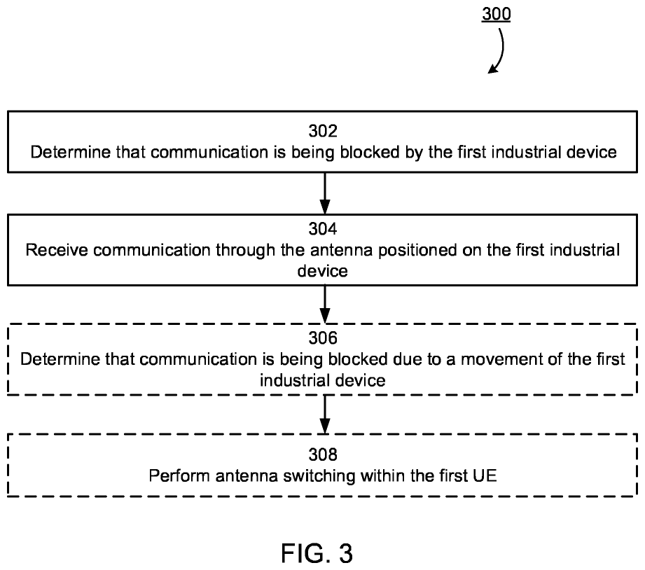

FIG. 3 is a flowchart illustrating example method steps of a method 300 performed by the first UE for receiving communication from the network node, when the communication is being blocked by the first industrial device in the industrial environment. The first UE may be connected to the first industrial device and the network node. Although the embodiments described herein may be equally applicable for the plurality of UEs connected to the plurality of industrial devices, the embodiments herein are described by considering the first UE among the plurality of UEs, which performs the method steps for receiving the communication from the network node.

At step 302, the method 300 comprises determining that the communication to the first UE from the network node is being blocked by the first industrial device. In some examples, the communication may be blocked by at least one actuator of the first industrial device. The at least one actuator may be used by the first industrial device to perform one or more operations.

In some embodiments, the first UE determines that the communication is being blocked by the first industrial device based on an operating state of the first industrial device. In some examples, the operating state of the first industrial device indicates whether the first industrial device is stationary or performing one or more operations, which may block the intended communication to the first UE.

The first UE may determine the operating state of the first industrial device using information received from one or more of: one or more sensors positioned on the first industrial device, and the industrial controller configured for controlling each industrial device in the industrial environment.

In some examples, the one or more sensors positioned on the first industrial device may include, but are not limited to, motion sensors, location/direction sensors, inertial sensors, or any other similar sensors. The inertial sensors may include an accelerometer, a gyroscope, or the like. The one or more sensors may be used to sense one or more of: a movement/motion of the first industrial device, location of the first industrial device, a direction of motion of the first industrial device, or the like. A function of each sensor may be intuitively referred by those skilled in the art based on its name, thus a detailed description is omitted.

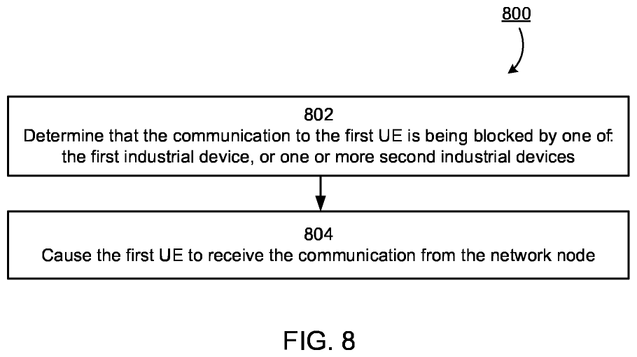

In some examples, the information received from the industrial controller may indicate that the communication is being determined to be blocked by the first industrial device. The industrial controller may determine that the communication is being blocked by the first industrial device based on the information received from the one or more sensors positioned on the first industrial device, and a movement of the first industrial device (as described in conjunction with FIG. 8).

While the communication is determined to be blocked by the first industrial device, at step 304, the method 300 comprises receiving the communication from the network node through an antenna positioned on the first industrial device.

The first UE may further perform optional steps 306, and 308.

At step 306, the method 300 further comprises determining that the communication is being blocked from the network node due to the movement of the first industrial device. In some examples, the movement of the first industrial device includes one or more of: rotation of the first industrial device, change in location of the first industrial device, or a combination thereof.

While determined that the communication is being blocked due to the movement of the first industrial device, at step 308, the method 300 comprises determining to perform an antenna switching within the first UE for receiving the communication from the network node. The first UE performs the antenna switching, as the first UE includes multi-directive antennas. The antenna switching performed by the first UE includes switching to at least one antenna of the first UE for reception of the communication from the network node.

In an embodiment, the first UE may perform the antenna switching based on the operating state of the first industrial device. The first UE may determine the operating state of the first industrial device based on the information received from one or more of: the one or more sensors positioned on the first industrial device, and the industrial controller.

Upon determining to perform the antenna switching, the first UE transmits an indication to the network node indicating that the first UE is likely to perform the antenna switching. The indication may indicate the at least one antenna determined by the first UE to receive the communication. In response to receiving the indication from the network node, the network node prepares to transmit the communication to the first UE in accordance with the antenna switching to be performed by the first UE. The network node prepares to transmit the communication by identifying a beam other than a serving beam based on the at least one antenna determined to be used by the first UE for receiving the communication. The network node switches from the serving beam to the identified at least one beam for transmitting the communication to the first UE.

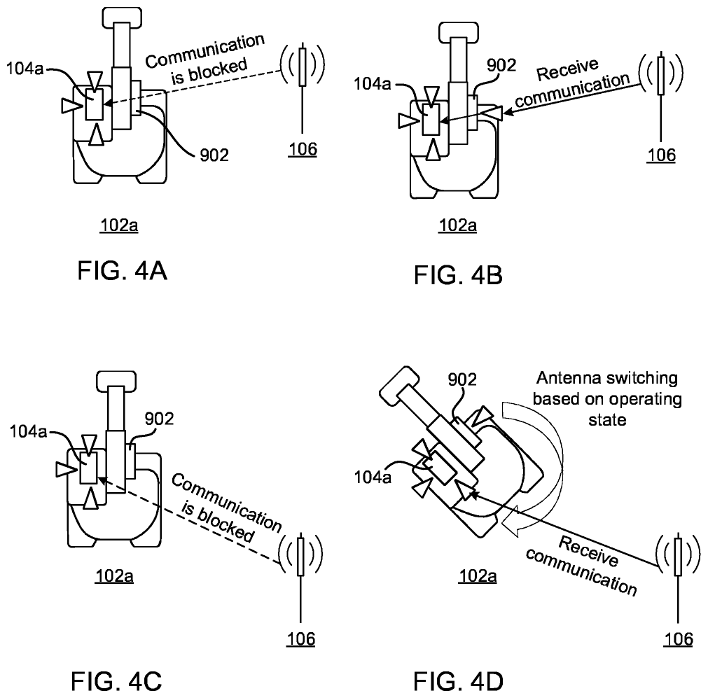

FIGS. 4A-4D disclose example illustrations for receiving communication by the first UE 104a from the network node 106, when the communication is being blocked by the first industrial device 102a.

As depicted in FIGS. 4A-4D, the first UE 104a may be connected to the first industrial device 102a. The first UE 104a may include one or more multi-directive antennas for receiving the communication from the network node 106. The multi-directive antenna may be able to receive communication from the network node 106 from multiple directions.

The first industrial device 102a may comprise of at least one actuator (for example, servos, arms, or the like) to perform one or more operations in accordance with control messages generated by the industrial controller. Further, an antenna 902 is positioned on the first industrial device 102a to enable the first UE 104a to receive the communication from the network node 106, when the communication is being blocked by the first industrial device 102a.

According to some embodiments of the present disclosure, the first UE 104a receives information from one or more of: one or more sensors positioned on the first industrial device 102a, and the industrial controller configured to control the first industrial device 102a. The information received from the one or more sensors may indicate a movement/motion of the first industrial device 102a, location of the first industrial device 102a, a direction of motion of the first industrial device 102a, and so on. The information received from the industrial controller may indicate that the communication is determined to be blocked by the first industrial device 102a. The first UE 104a may receive the information from the industrial controller through the network node 106.

The first UE 104 determines the operating state of the first industrial device 102a based on the received information. The operating state may indicate whether the first industrial device 102a is stationary or the first industrial device 102a is performing at least one operation.

Upon determining the operating state of the first industrial device 102a, the first UE 104 determines whether the communication is being blocked by the first industrial device 102a using the operating state of the first industrial device 102a.

In an example herein, the first UE 104a determines that the communication is being blocked from the network node 106 by the first industrial device 102a, as depicted in FIG. 4A. Upon determining that the communication is being blocked by the first industrial device 102a, the first UE 104a receives the communication from the network node 106 through the antenna 902 positioned on the first industrial device 102a, as depicted in FIG. 4B.

Further, while the first UE 104a is receiving the communication from the network node 106 through the antenna 902 positioned on the first industrial device 102a, the first industrial device 102a may rotate or move. In such a scenario, the first UE 104a determines whether the movement of the first industrial device 102a is blocking the communication from the network node 106. In an example herein, the first UE 104a determines that the communication is being blocked due to the movement of the first industrial device 102a, as depicted in FIG. 4C.

Upon determining that the communication is being blocked due to the movement of the first industrial device 102a, the first UE 104a determines to switch to at least one antenna of the first UE 104a to receive the communication, based on the operating state of the first industrial device 102a. The first UE 104a switches to the determined at least one antenna for receiving the communication from the network node 106, as depicted in FIG. 4D. Switching to the at least one antenna based on the operating state of the industrial device may reduce time required for switching to the at least one antenna.

The first UE 104a further transmits an indication to the network node 106 indicating that the first UE 104a is determined to switch to the at least one antenna for receiving the communication. In accordance with the received indication, the network node 106 may switch from a serving beam to at least one another beam and transmit the communication to the first UE 104a over the switched at least one another beam. Thus, the first UE 104a and the network node 106 may operate synchronously to prepare for antenna switching with reduced signaling and switching time.

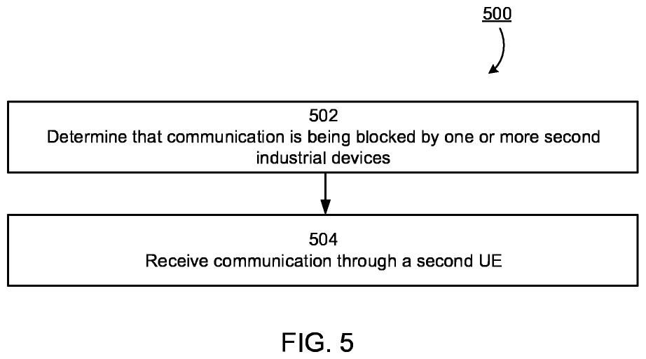

FIG. 5 is a flowchart illustrating example method steps of a method 500 performed by the first UE for receiving communication from the network node, when the communication is being blocked by the one or more second industrial devices in the industrial environment. The first UE may be connected to the first industrial device and the network node. The one or more second UEs may be connected to the one or more second industrial devices.

At step 502, the method 500 comprises determining that the communication to the first UE is being blocked by the one or more second industrial devices present in the industrial environment.

In some embodiments, the first UE determines that the communication is being blocked by the one or more second industrial devices based on an operating state of the one or more second industrial devices. In some examples, the operating state of the one or more second industrial devices indicates whether the one or more second industrial devices are stationary or performing one or more operations. The first UE may determine the operating state of the one or more second industrial devices using information received from one or more of: one or more sensors positioned on the one or more second industrial devices, and the industrial controller configured for controlling each industrial device in the industrial environment.

In some examples, the one or more sensors positioned on the one or more second industrial devices may include, but are not limited to, motion sensors, location/direction sensors, inertial sensors, or any other similar sensors. The inertial sensors may include an accelerometer, a gyroscope. The one or more sensors may be used to sense one or more of: a movement of the one or more second industrial devices, location/direction of the movement of the one or more second industrial devices, or the like. A function of each sensor may be intuitively inferred by one of those skilled in the art based on its name, and thus, its detailed description is omitted.

In some examples, the information received from the industrial controller may indicate that the communication is determined to be blocked by the one or more second industrial devices in the industrial environment. The industrial controller may determine that the communication is determined to be blocked by the one or more second industrial devices in the industrial environment based on the information received from the one or more sensors positioned on the one or more second industrial devices, and a movement related to the one or more second industrial devices (as disclosed in conjunction with FIG. 8).

While determined that the communication is being blocked by the one or more second industrial devices, at step 504, the method 500 comprises receiving the communication by the first UE through the second UE connected to the second industrial device. The first UE receives, from the industrial controller, an indication to receive the communication from the network node through the second UE connected to the second industrial device. The indication indicates the second UE from which the first UE may receive the communication from the network node. The first UE receives the communication from the network node through the second UE.

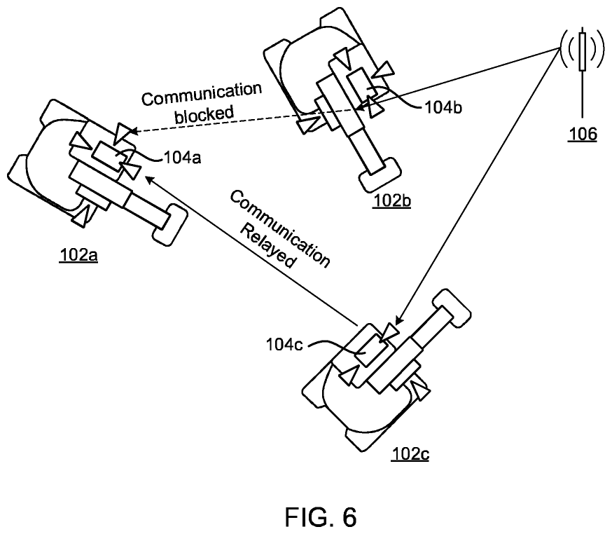

FIG. 6 discloses an example illustration for receiving communication by the first UE 104a from the network node 106, when the communication is being blocked by the one or more second devices 102b-102c. As depicted in FIG. 6, the industrial environment comprises a plurality of industrial devices 102a, 102b, and 102c, and a plurality of UEs 104a, 104b, and 104c. The first industrial device 102a may be connected to the first UE 104a. The second industrial devices 102b, and 102c may be connected to the second UEs 104b, and 104c. Further, the first UE 104a, and the second UEs 104a-104c may be connected to the network node 106.

The first UE 104a receives information from one or more of: one or more sensors positioned on each of the plurality of industrial devices 102a-102c and the industrial controller configured to control each industrial device in the industrial environment. The information received from the one or more sensors may indicate one or more of: a movement of each industrial device, a location/direction of each industrial device, or the like. The information received from the industrial controller may indicate that the communication is determined to be blocked by the second industrial device 102b.

The first UE 104a determines an operating state of each of the second industrial devices 102b-102c using the received information. The operating state may indicate whether the industrial device is stationary, or performing one or more operations.

The first UE 104a determines whether the communication is being blocked by the one or more second industrial devices 102b-102c, based on the operating state of the one or more second industrial devices 102b-102c. In an example herein, the first UE 104a determines that the second industrial device 102b is blocking the communication from the network node 106 for the first UE 104a.

While determined that the second industrial device 102b is blocking the communication, the first UE 104a receives the communication from the network node 106 through the second UE 104c connected to the second industrial device 102c. The second UE 104c may be indicated by the industrial controller to enable the first UE 104a to receive the communication from the network node through the second UE 104c.

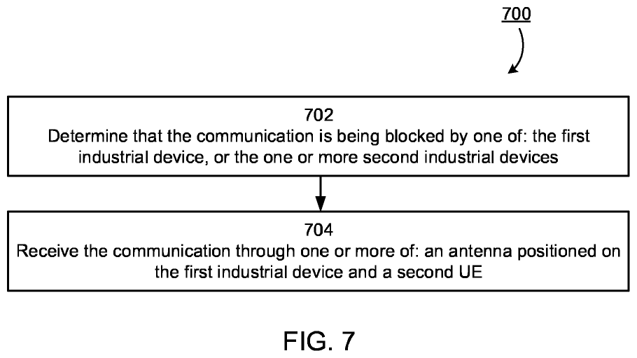

FIG. 7 is a flowchart illustrating example method steps of a method 700 performed by the first UE for receiving communication from the network node in the industrial environment. The industrial environment comprises the plurality of industrial devices. The first industrial device may be connected to the first UE, and the one or more second industrial devices may be connected to the one or more second UEs.

At step 702, the method 700 comprises determining whether the communication to the first UE is being blocked by one of: the first industrial device, or the one or more second industrial devices in the industrial environment.

In some embodiments, the step 702 of determining whether the communication to the first UE is being blocked by one of: the first industrial device, or the one or more second industrial devices in the industrial environment comprises one or more of: identifying whether the first industrial device is blocking the communication from the network node to the first UE using an operating state of the first industrial device, and identifying whether the one or more second industrial devices are blocking the communication from the network node to the first UE using an operating state of the one or more second industrial devices. The operating state of the first industrial device/one or more second industrial devices may indicate whether the first industrial device/one or more second industrial devices is stationary or performing one or more operations.

The first UE determines the operating state of the first industrial device/one or more second industrial devices using information received from one or more of: one or more sensors positioned on the first industrial device and/or the one or more sensors positioned on the one or more second industrial devices, and the industrial controller configured for controlling each industrial device in the industrial environment.

In some examples, the one or more sensors may include one or more of: motion sensors, location/direction sensors, inertial sensors, and so on. The inertial sensors may include one or more of: accelerometers, a gyroscope, or the like. In some examples, the information received from the industrial controller indicates that the communication is determined to be being blocked by the first industrial device or the one or more second industrial devices.

While the communication is determined to be blocked, at step 704, the method 700 comprises receiving the communication from the network node through one or more of: an antenna positioned on the first industrial device, and the second UE connected to the second industrial device.

In some embodiments, the step 704 of receiving the communication from the network node through one or more of: the antenna positioned on the first industrial device, and the second UE connected to the second industrial device comprises determining whether the first industrial device is blocking the communication from the network node. While determined that the first industrial device is blocking the communication (as described above in conjunction with FIG. 4A), the method comprises receiving the communication from the network node through the antenna positioned on the first industrial device (as described above in conjunction with FIG. 4B).

The method further comprises identifying that the communication is blocked for the first UE due to a movement (for example, rotation, moving from one place to another, or the like) of the first industrial device (as described above in conjunction with FIG. 4C). While the communication is determined to be blocked, the method comprises determining to switch to at least one antenna of the first UE for the reception of communication from the network node (as described above in conjunction with FIG. 4D). The switching to the at least one antenna may be based on the operating state of the first industrial device.

The method further comprises determining whether the one or more second industrial devices are blocking the communication from the network node. While determined that the one or more second industrial devices are blocking the communication from the network node, the method comprises receiving the communication from the network node through the second UE connected to the second industrial device.

In some embodiments, the step of receiving the communication from the network node through the second UE connected to the second industrial device comprises receiving, from the industrial controller, an indication to receive the communication from the network node through the second UE. The method comprises receiving the communication from the network node through the second UE (as described above in conjunction with FIG. 6).

FIG. 8 is a flowchart illustrating example method steps of a method 800 performed by the industrial controller for enabling the first UE for reception of communication from the network node in the industrial environment. The industrial environment comprises the plurality of industrial devices. The first industrial device may be connected to the first UE, and the one or more second industrial devices may be connected to the one or more second UEs. The industrial controller may be connected to the network node.

At step 802, the method 800 comprises determining that the communication to the first UE is being blocked by one of: the first industrial device, or the one or more second industrial devices in the industrial environment.

In some embodiments, the step 802 of determining that the communication to the first UE is being blocked by one of: the first industrial device, or the one or more second industrial devices in the industrial environment comprises receiving sensor data acquired using one or more sensors positioned on each of the plurality of industrial devices. The industrial controller may receive the sensor data acquired using the one or more sensors through the network node. In some examples, the one or more sensors may include one or more of: motion sensors, location/direction sensors, inertial sensors, and so on. The inertial sensors may include one or more of: an accelerometer, a gyroscope, or the like. The sensor data may indicate one or more of: a movement/motion of each industrial device, a location of each industrial device, a direction of motion of each industrial device, and so on.

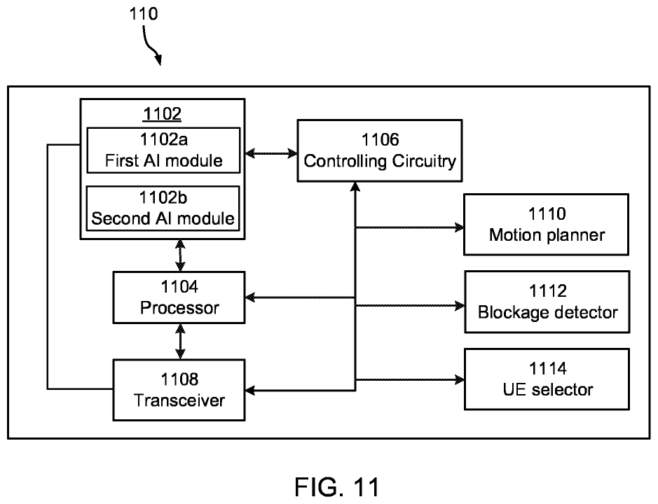

Upon receiving the sensor data, the method comprises receiving information related to a movement of the plurality of industrial devices. The industrial controller may receive information related to the movement of the plurality of industrial devices from a motion planner (as described in conjunction with FIG. 11). The motion planner may determine the movement of the plurality of industrial devices using the sensor data and one or more operations assigned for the plurality of industrial devices to perform in the industrial environment.

The method comprises determining that the communication to the first UE is being blocked by one of: the first industrial device, or the one or more second industrial devices using the sensor data and the information related to the movement of the plurality of industrial devices.

In an embodiment, the industrial controller may use an first Artificial Intelligence, AI, model (as described in conjunction with FIG. 11) to determine that the communication is being blocked by one of: the first industrial device, or the one or more second industrial devices based on the sensor data and the information related to the movement of the plurality of industrial devices.

In some examples, the first AI model may also include, but are not limited to, a neural network model, a machine learning model, a multi-class support vector machine, SVM, model, a recurrent neural network, RNN, model, a restricted Boltzmann machine, RBM, model, a deep belief network, DBN, model, a generative adversarial network, GAN, model, a regression based neural network model, a deep reinforcement model, a deep Q-network model, and so on. The first AI model may include a plurality of nodes arranged in layers. Examples of the layers may include, but are not limited to, a convolutional layer, a concatenated layer, a dropout layer, a fully connected layer, a SoftMax layer, and so on. Each layer has weights and performs a layer operation through calculation of a previous layer and an operation of a plurality of weights/coefficients.

In some examples, the first AI model may be trained by applying one or more learning methods on training data for determining that the communication is being blocked by the first industrial device, or the one or more second industrial devices. In some examples, the training data include one or more of: sensor data collected from the one or more sensors positioned on the plurality of industrial devices for a period of time, information related to the one or more operations performed by the plurality of industrial devices in the industrial environment over time, information related to communications being blocked by the one or more industrial devices previously due to the associated one or more operations, and so on. In some examples, the learning methods may include one or more of: a supervised learning method, an unsupervised learning method, a semi-supervised learning method, a reinforcement learning method, and a regression-based learning based method. The trained first AI model may include a known and fixed number of layers, and sequence for processing the layers and parameters related to each layer. The parameters may include one or more of: activation functions, biases, input weights, output weights, and so on, related to the layers. A function associated with the learning method may be performed through a memory, and a controlling circuitry. The controlling circuitry may include one or more processors such as, a central processing unit, CPU, an application processor, AP, a graphics processing unit, GPU, a visual processing unit, VPU, an AI dedicated processor (like neural processing unit, NPU), and so on.

The industrial controller processes the sensor data, and the information related to the movement of the plurality of industrial devices using the trained first AI model and determines that the communication is being blocked for the first UE by the first industrial device, or the one or more second industrial devices.

Upon determining that the communication to the first UE is being blocked, the method further comprises transmitting an indication to the first UE, and the network node indicating that the communication to the first UE is being blocked by one of: the first industrial device, or the one or more second industrial devices. The industrial controller transmits the indication to the first UE through the network node. Thus, the first UE and the network node may prepare for receiving and transmitting communication, respectively with reduced signalling and antenna switching time, based on the received indication.

While the communication is determined to be blocked, at step 804, the method 800 comprises causing the first UE to receive the communication from the network node through one or more of: the antenna positioned on the first industrial device and the second UE connected to the second industrial device. The industrial device may cause the first UE to receive the communication from the network node through the antenna positioned on the first industrial device, when it is determined that the communication is being blocked by the first industrial device for the first UE. The industrial device may cause the first UE to receive the communication from the network node through the second UE, when it is determined that the communication is being blocked by the one or more second industrial devices.

In an embodiment, the step of causing the first UE to receive the communication from the network node through the second UE comprises determining the second UE and an antenna of the second UE to be used to relay the communication from the network node to the first UE. The method further comprises transmitting, to the first UE, an indication related to the second UE to cause the first UE to receive the communication from the network node.

In an embodiment, the step of determining the second UE and the antenna of the second UE comprises determining a traffic condition of the one or more UEs (including the first UE and the one or more second UEs) connected to the one or more industrial devices. The method comprises determining radio channel conditions between the network node and the one or more UEs for communication to the one or more UEs. The method comprises determining the second UE and the antenna of the second UE to be used to relay the communication from the network node using the traffic condition of the one or more second UEs and the radio channel conditions.

In an embodiment, the industrial controller may use a second AI model (as described in conjunction with FIG. 11) to determine the second UE and the antenna of the second UE based on the traffic condition of the one or more second UEs and the radio channel conditions.

The second AI model may include similar structure of the first AI model and the second AI model may be trained similar to training of the first AI model, thus a repeated description is omitted herein.

The industrial controller processes the traffic conditions of the one or more UEs, and the radio channel conditions using the trained second AI model to detect the second UE and the antenna of the second UE to be used to relay the communication from the network node to the first UE.

In some examples, the industrial controller may also transmit an indication to the second UE to relay the communication from the network node to the first UE. In some examples, the industrial controller may also transmit an indication to the one or more UEs present in the industrial environment indicating that the second UE is relaying the communication from the network node to the first UE.

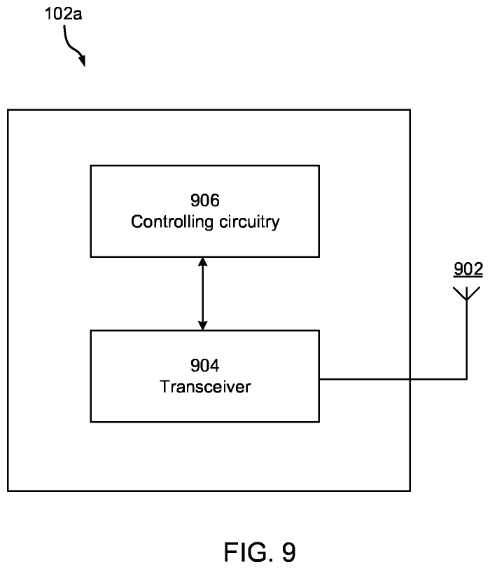

FIG. 9 is an example schematic diagram showing an apparatus 102a. The apparatus 102a may e.g. be comprised in any of the industrial devices present in the industrial environment, for example, the first industrial device. The first industrial device may be connected to the first UE.

According to at least some embodiments of the present invention, the apparatus 102a in FIG. 9 comprises one or more modules. These modules may e.g. be a transceiver 904, and a controlling circuitry 906. Further, an antenna 902 may be positioned on the apparatus 102a. The controlling circuitry 906, may in some embodiments be adapted to control the above mentioned modules.

The antenna 902, the transceiver 904, and the controlling circuitry 906 may be operatively connected to each other.

The antenna 902 may be adapted to receive communication from the network node, and transmit the received communication to the first UE connected to the first industrial device. Thus, enabling the first UE to receive the communication from the antenna positioned on the first industrial device.

The transceiver 904 may be adapted to receive control messages from the network node through the first UE. The transceiver 904 may also be adapted to transmit sensor data acquired from one or more sensors (not shown) positioned on the first industrial device to the industrial controller through the network node.

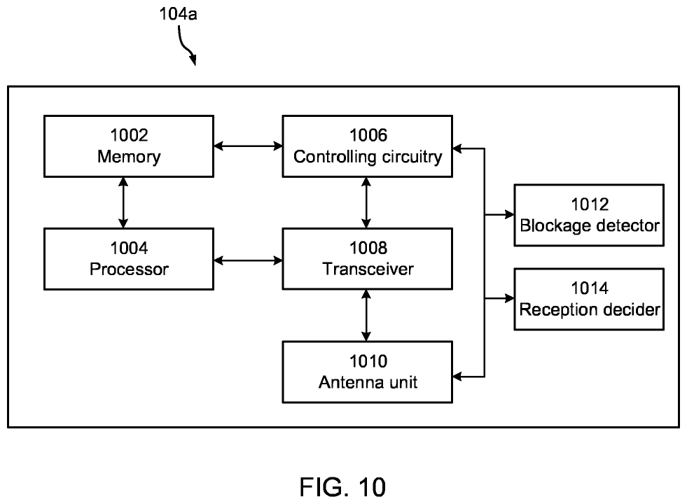

The controlling circuitry 906 may be adapted to enable the industrial device to perform one or more operations in accordance with the control messages received from the industrial controller. FIG. 10 is an example schematic diagram showing an apparatus 104a. The apparatus 104a may e.g. be comprised in any of the UEs present in the industrial environment, for example, the first UE. The industrial environment comprises the plurality of industrial devices, the first industrial device may be connected to the first UE, and the one or more second industrial devices may be connected to the one or more second UEs.

The apparatus 104a is capable of receiving the communication from the network node and may be configured to cause performance of the method 300, 500, and 700 for receiving the communication in the industrial environment.

According to at least some embodiments of the present invention, the apparatus 104a in FIG. 10 comprises one or more modules. These modules may e.g. be a memory 1002, a processor 1004, a controlling circuitry 1006, a transceiver 1008, an antenna unit 1010, a blockage detector 1012, and a reception decider 1014. The controlling circuitry 1006, may in some embodiments be adapted to control the above mentioned modules.

The memory 1002, a processor 1004, a transceiver 1008, an antenna unit 1010, a blockage detector 1012, and a reception decider 1014 as well as the controlling circuitry 1006, may be operatively connected to each other.

The controlling circuitry 1006 may be adapted to control the steps as executed by the first UE. For example, the controlling circuitry 1006 may be adapted to receive the communication from the network node (as described above in conjunction with the method 300, 500, and 700, and FIGS. 3, 5, and 7 respectively).

The antenna unit 1010 may comprise of at least one multi-directive antenna configured to receive the communication from the network node from multiple directions.

The transceiver 1008 may be adapted to receive information one or more of: one or more sensors positioned on the one or more industrial devices, and the industrial controller. The transceiver 1008 may also receive an indication from the industrial controller indicating the second UE to receive the communication.

The blockage detector 1012 may be adapted to determine whether the communication to the first UE is being blocked by one of: the first industrial device, or the one or more second industrial devices in the industrial environment, based on the operating state of the first industrial device and the one or more second industrial devices. The operating state may be determined based on the received information.

The blockage detector 1012 may also be adapted to identify that the communication is being blocked due to a movement of the first industrial device. The blockage detector 1012 decides to switch to the at least one antenna in the antenna unit 1010 to receive the communication from the network node based on the operating state of the industrial device.

The reception decider 1014 may be adapted to determine to receive the communication from the network node through one or more of: an antenna positioned on the first industrial device, and the second UE connected to the second industrial device, while determined that the communication is being blocked.

Further, the processor 1004 may be adapted to enable the at least one antenna in the antenna unit 1010 determined to be switched to receive the communication.

Furthermore, the memory 1002 is adapted to store the received information, indication, or the like.

FIG. 11 is an example schematic diagram showing an apparatus 110. The apparatus 110 may e.g. be comprised in the industrial controller. The industrial controller may control the plurality of industrial devices in the industrial environment, the first industrial device may be connected to the first UE, and the one or more second industrial devices may be connected to the one or more second UEs.

The apparatus 110 is capable of enabling the first UE for reception of the communication from the network node and may be configured to cause performance of the method 800 for enabling the first UE for reception of the communication from the network node.

According to at least some embodiments of the present invention, the apparatus 110 in FIG. 11 comprises one or more modules. These modules may e.g. be a memory 1102, a processor 1104, a controlling circuitry 1106, a transceiver 1108, a motion planner 1110, a blockage detector 1112, and a UE selector 1114. The controlling circuitry 1106, may in some embodiments be adapted to control the above mentioned modules.

The memory 1102, the processor 1104, the transceiver 1108, the motion planner 1110, the blockage detector 1112, and the UE selector 1114 as well as the controlling circuitry 1106, may be operatively connected to each other.

The controlling circuitry 1106 may be adapted to control the steps as executed by the industrial controller. For example, the controlling circuitry 1106 may be adapted to enable the first UE to receive the communication from the network node (as described above in conjunction with the method 800 and FIG. 8).

The transceiver 1108 may be adapted to receive sensor data acquired from one or more sensors positioned on the plurality of industrial devices in the industrial environment.

The motion planner 1110 may be adapted to determine the movement of the plurality of industrial devices based on one or more operations assigned for the plurality of industrial devices and the acquired sensor data.

The blockage detector 1112 may be adapted to determine whether the communication to the first UE is being blocked by one of: the first industrial device, or the one or more second industrial devices in the industrial environment, by processing the sensor data and information related to the movement of the plurality of industrial devices using a first AI model 1102a (as described above in conjunction with FIG. 8).

The transceiver 1108 may also adapted to transmit an indication to the first UE and/or the network node indicating that the communication is determined to be blocked by the first industrial device or the one or more second industrial devices.

The UE selector 1114 may be adapted to determine the second UE and the antenna of the second UE to be used for relaying the communication from the network node to the second UE. The UE selector 114 determines the second UE and the antenna of the second UE by processing traffic conditions of the one or more UEs, and radio channel conditions using a second AI model 1102b (as described in conjunction with FIG. 8).

The transceiver 1108 may also be adapted to transmit an indication to the first UE indicating the second UE to receive the communication.

Further, the processor 1104 may be adapted to train the first AI model 1102a and the second AI model 1102b.

Furthermore, the memory 1102 is adapted to store the first AI model 1102a, the second AI model 1102b, the sensor data, the one or more operations assigned for the plurality of industrial devices, information related to the determined second UE and the associated antenna, or the like.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

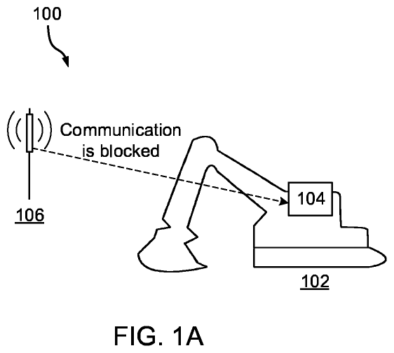

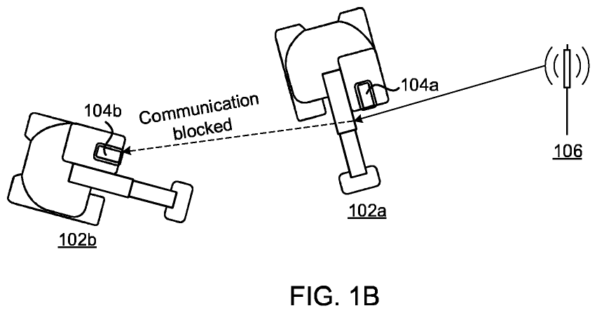

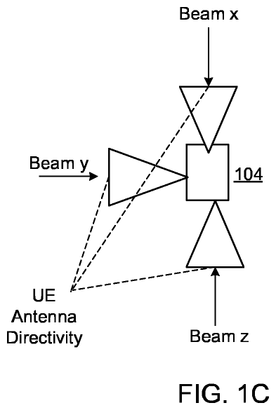

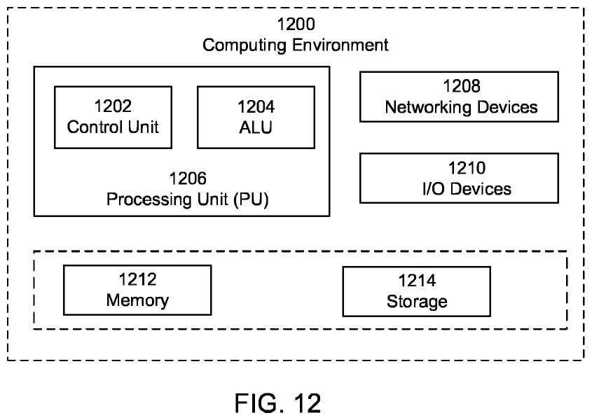

FIG. 12 illustrates an example computing environment 1200 implementing a method and the first UE, and the industrial controller, as described in FIG. 3, FIG. 5, FIG. 7, and FIG. 8. As depicted in FIG. 12, the computing environment 1200 comprises at least one data processing module 1206 that is equipped with a control module 1202 and an Arithmetic Logic Unit (ALU) 1204, a plurality of networking devices 1208 and a plurality Input output, I/O devices 1210, a memory 1212, a storage 1214. The data processing module 1206 may be responsible for implementing the method described in FIG. 3, FIG. 5, FIG. 7, and FIG. 8. For example, the data processing module 1206 may in some embodiments be equivalent to the processor of the first UE, and the industrial controller described above in conjunction with the FIGS. 1-11. The data processing module 1206 is capable of executing software instructions stored in memory 1212. The data processing module 1206 receives commands from the control module 1202 in order to perform its processing. Further, any logical and arithmetic operations involved in the execution of the instructions are computed with the help of the ALU 1204.

The computer program is loadable into the data processing module 1206, which may, for example, be comprised in an electronic apparatus (such as the first UE, and the industrial controller). When loaded into the data processing module 1206, the computer program may be stored in the memory 1212 associated with or comprised in the data processing module 1206.

According to some embodiments, the computer program may, when loaded into and run by the data processing module 1206, cause execution of method steps according to, for example, the method illustrated in FIG. 3, FIG. 5, FIG. 7, and FIG. 8 or otherwise described herein.

The overall computing environment 1200 may be composed of multiple homogeneous and/or heterogeneous cores, multiple CPUs of different kinds, special media and other accelerators. Further, the plurality of data processing modules 1206 may be located on a single chip or over multiple chips.

The algorithm comprising of instructions and codes required for the implementation are stored in either the memory 1212 or the storage 1214 or both. At the time of execution, the instructions may be fetched from the corresponding memory 1212 and/or storage 1214, and executed by the data processing module 1206.

In case of any hardware implementations various networking devices 1208 or external I/O devices 1210 may be connected to the computing environment to support the implementation through the networking devices 1208 and the I/O devices 1210.

The embodiments disclosed herein can be implemented through at least one software program running on at least one hardware device and performing network management functions to control the elements. The elements shown in FIG. 12 include blocks which can be at least one of a hardware device, or a combination of hardware device and software module.

1. A method performed by a first user equipment (UE), for reception of communication from a network node in an industrial environment, the industrial environment comprising a plurality of industrial devices, a first industrial device being connected to the first UE, and one or more second industrial devices being connected to one or more second UEs, the method comprising:
determining whether the communication to the first UE is being blocked by one of: the first industrial device, or the one or more second industrial devices, in the industrial environment; and
while the communication is determined to be blocked, receiving the communication from the network node through one or more of: an antenna positioned on the first industrial device, and a second UE connected to the second industrial device.

2. The methodaccording to claim 1, wherein the step of determining whether the communication to the first UE is being blocked by one of: the first industrial device, or the one or more second industrial devices comprises one or more of:
identifying whether the first industrial device is blocking the communication from the network node to the first UE using an operating state of the first industrial device; and
identifying whether the one or more second industrial devices are blocking the communication from the network node to the first UE using an operating state of the one or more second industrial devices.

3. The method according to claim 2, wherein the operating state of the first industrial device and/or the operating state of the one or more second industrial devices is determined using information received from one or more of:
one or more sensors positioned on the first industrial device, and/or one or more sensors positioned on the one or more second industrial devices; and
an industrial controller configured for controlling each industrial device in the industrial environment.

4. The method according to claim 1, wherein the step of receiving the communication from the network node through one or more of: the antenna positioned on the first industrial device, and the second UE connected to the second industrial device comprises:
determining whether the first industrial device is blocking the communication from the network node; and
while determined that the first industrial device is blocking the communication, receiving the communication from the network node through the antenna positioned on the first industrial device.

5. The method-according to claim 4, further comprising:
identifying that the communication is blocked for the first UE due to a movement of the first industrial device; and
determining to switch to at least one antenna of the first UE for the reception of communication from the network node, wherein switching to the at least one antenna is based on the determined operating state of the first industrial device.

6. The method according to claim 4, further comprising:
determine whether the one or more second industrial devices are blocking the communication from the network node; and
while determined that the one or more second industrial devices are blocking the communication from the network node, receiving the communication from the network node through the second UE connected to the second industrial device.

7. The method according to claim 6, wherein the step of receiving the communication from the network node through the second UE connected to the second industrial device comprises:
receiving, from an industrial controller, an indication to receive the communication from the network node through the second UE; and
receiving the communication from the network node through the second UE.

8. A method for enabling a first user equipment, (UE) for reception of communication from a network node, in an industrial environment, the industrial environment comprising a plurality of industrial devices, each industrial device being connected to a UE, the method being performed by an industrial controller connected to the network node, the method comprising:
determining that the communication to the first UE is being blocked by one of: a first industrial device, or one or more second industrial devices, in the industrial environment; and
causing the first UE to receive the communication from the network node through one or more of: an antenna positioned on the first industrial device, and a second UE connected to the second industrial device.

9. The method according to claim 8, wherein the step of determining that the communication to the first UE is being blocked by one of: the first industrial device, or the one or more second industrial devices in the industrial environment comprises:
receiving, sensor data, acquired using one or more sensors positioned on each of the plurality of industrial devices;
receiving information related to a movement of the plurality of industrial devices; and
determining that the communication to the first UE is being blocked by one of: the first industrial device , or the one or more second industrial devices using the sensor data and the information related to the movement of the plurality of industrial devices.

10. The method according to claim 8, wherein the step of causing the first UE to receive the communication from the network node comprises:
determining the second UE and an antenna of the second UE to be used to relay the communication from the network node to the first UE through the second UE; and
transmitting, to the first UE, an indication related to the second UE to cause the first UE to receive the communication from the network node.

11. The method according to claim 10, wherein the step of determining the second UE and the antenna of the second UE to be used to relay the communication from the network node to the first UE through the second UE comprises:
determining a traffic condition of one or more UEs connected to the one or more industrial devices;
determining radio channel conditions between the network node and the one or more UEs for communication to the one or more UEs; and
determining the second UE and the antenna of the second UE to be used to relay the communication from the network node using the traffic condition of the one or more second UEs and the radio channel conditions.

12. A first user equipment (UE), configured to operate in an industrial environment for reception of communication from a network node, the industrial environment comprising a plurality of industrial devices, a first industrial device being connected to the first UE, and one or more second industrial devices being connected to one or more second UEs, the first UE comprising a controlling circuitry configured to cause:
determination of whether the communication to the first UE is being blocked by one of: the first industrial device, or the one or more second industrial device, in the industrial environment; and
while the communication is determined to be blocked, reception of the communication from the network node through one or more of: an antenna positioned on the first industrial device, and a second UE connected to the second industrial device.

13. The first UE according to claim 12, wherein the controlling circuitry is configured to cause the step of determination of whether the communication to the first UE is being blocked by one of: the first industrial device, or the one or more second industrial devices by causing one or more of:
identification of whether the first industrial device is blocking the communication from the network node to the first UE using an operating state of the first industrial device; and
identification of whether the one or more second industrial devices are blocking the communication from the network node to the first UE using an operating state of the one or more second industrial devices.

14. The first UE according to claim 13, wherein the operating state of the first industrial device and/or the operating state of the one or more second industrial devices is determined using information received from one or more of:
one or more sensors positioned on the first industrial device, and/or one or more sensors positioned on the one or more second industrial devices; and
an industrial controller configured for controlling each industrial device in the industrial environment.

15. The first UE according to claim 12, wherein the controlling circuitry is configured to cause the step of reception of the communication from the network node through one or more of: the antenna positioned on the first industrial device, and the second UE connected to the second industrial device by causing:
determination of whether the first industrial device is blocking the communication from the network node; and
while determined that the first industrial device is blocking the communication, reception of the communication from the network node through the antenna positioned on the first industrial device.

16. The first UE according to claim 15, wherein the controlling circuitry is further configured to cause:
identification of that the communication is blocked for the first UE due to a movement of the first industrial device; and
determination to switch to at least one antenna of the first UE for the reception of communication from the network node, wherein switching to the at least one antenna is based on the determined operating state of the first industrial device.

17. The first UE according to claim 15, wherein the controlling circuitry is further configured to cause:
determination of whether the one or more second industrial devices are blocking the communication from the network node; and
while determined that the one or more second industrial devices are blocking the communication from the network node, reception of the communication from the network node through the second UE connected to the second industrial device.

18. The first UE according to claim 17, wherein the controlling circuitry is configured to cause the step of reception of the communication from the network node through the second UE connected to the second industrial device by causing:
reception, from an industrial controller, an indication to receive the communication from the network node through the second UE; and
reception of the communication from the network node through the second UE.

19-23. (canceled)

24. A computer program product comprising a non-transitory computer readable medium, having thereon a computer program comprising program instructions, wherein the computer program is loadable into a data processing unit and configured to cause execution of the method according to claim 1 when the computer program is run by the data processing unit.
